(19) United States
(12) Patent Application Publication
(10) Pub. No.: US 2009/0083943 A1
(43) Pub. Date: Apr. 2, 2009

(54) STOPPING AND POSITIONING MECHANISM FOR PIVOTAL DEVICE

(76) Inventor: Chung Wei CHEN, Sinjhuang City (TW)

Correspondence Address: SINORICA, LLC, 528 FALLSGROVE DRIVE, ROCKVILLE, MD, 20850, US

(21) Appl. No.: 12/147,614

(22) Filed: Jun. 27, 2008

(30) Foreign Application Priority Data
Sep. 28, 2007 (TW) 096136128

(51) Int. Cl. E05C 17/64

(52) U.S. Cl. 16/342

(57) ABSTRACT

The present invention discloses a stopping and positioning mechanism for pivotal device, comprising a fixing part having a notch; a positioning part having a through hole and a protrusion; and a pivoting axle having a positioning portion; wherein the fixing part is disposed with a wrapping part therein, the protrusion of the positioning part is securingly fixed onto the notch of the fixing part, and the pivoting axle is passing through the through hole of the positioning part and pivoted within the wrapping part; when the pivoting axle is rotating, the positioning portion of the pivoting axle is abutted against the stop portion of the positioning part, thereby limiting the rotation angle of the pivoting axle.

### FIELD OF THE INVENTION

The present invention relates to a stopping and positioning mechanism and in particular to a stopping and positioning mechanism for pivotal device.

### BACKGROUND OF THE INVENTION

Consumer electronics with flip covers, such as portable computer, electronic dictionary, portable audio/video player, flip mobile phone, generally have a main body on the bottom, which is pivotally connected with the cover body on the top, such that the cover body may swing open or close with respect to the main body. Consequently, the rotating axle is key to the quality of the products described above.

“WRAPPED LIMITING STRUCTURE FOR ROTATING AXLE,” developed by the present inventor, is disclosed in the ROC Patent No. M317737 (corresponding to the PRC Patent No. 200720004990.1). As shown in FIG. 1, the aforementioned patent has an axle 40 being socketingly connected and linking up with a limiting plate 50 and used to limit the opening angle by working with the front and rear stop edges 303 of the stop block 30. The stop block 30 is securingly fixed on one side of the fixing part 10 by the positioning notch 301 and connection hole 302, wherein the fixing part 10 is a die casting part, a zinc alloy for example, having an axle hole 101 whose internal surface is socketingly connected with an internal bush 20 for the inserting of the axle 40 and which is disposed with a positioning protrusion 102 and connection tenon 103 below the location adjacent with the stop block 30.

With the implementation of the aforementioned invention, though the failure of the fixing part 10 due to the limiting plate 50 can be reduced, the limiting plate 50 may be further improved by simplifying its structure so as to reduce its part number as well as cut down assembly and labor cost.

### SUMMARY OF THE INVENTION

In view of the foregoing shortcomings of the prior art, the inventor of the present invention based on years of experience in technology of rotating axle (pivotal device) hopes to improve the drawback of the limiting structure of the aforementioned pivotal device. The aim is to present a stopping and positioning mechanism with a simplified structure and assembly process, providing an enhanced service life as well as an improved positioning precision. After numerous experiments and tests, a stopping and positioning mechanism for pivotal device according to the present invention is achieved.

The main object and the improvement of the present invention is to simplify the components and assembly process of the stopping and positioning mechanism for pivotal device as well as provide an enhanced service life as well as an improved stopping and positioning precision of the pivotal device.

In order to accomplish the object described above, the present invention is to provide a stopping and positioning mechanism for pivotal device, comprising a fixing part having a notch; a positioning part having a through hole and a positioning protrusion; and a pivoting axle having a portion; wherein the fixing part is disposed with a wrapping part therein, the protrusion of the positioning portion is securingly fixed onto the notch of the fixing part, and the pivoting axle is passing through the through hole of the positioning part and pivoted within the wrapping part; when the pivoting axle is rotating, the positioning portion of the pivoting axle is abutted against the stop portion of the positioning part, thereby limiting the rotation angle of the pivoting axle.

Another technological approach adopt in the present invention is to provide a stopping and positioning mechanism for pivotal device, comprising a fixing part having a wrapping part therein; a positioning part having a through hole and a stop portion; and a pivoting axle having a positioning portion; wherein the positioning part is embeddedly positioned onto the fixing part, and the pivoting axle is passing through the through hole of the positioning part and pivoted within the wrapping part; when the pivoting axle is rotating, the positioning portion of the pivoting axle is abutted against the stop portion of the positioning part, thereby limiting the rotation angle of the pivoting axle.

### BRIEF DESCRIPTION OF THE DRAWINGS

The present invention can be more fully understood by reference to the following description and accompanying drawings, in which:

FIG. 1 is an exploded perspective view of a conventional rotating axle;

FIG. 2 is an exploded perspective view of a pivotal device according to the present invention;

FIG. 3 is an exploded perspective view of a pivotal device according to the present invention from another view angle;

FIG. 4 is a perspective assembly view of the present invention;

FIG. 5 is the rear perspective assembly view of the present invention;

FIG. 6 is the cross-sectional view taken through the C-C line in FIG. 5;

FIG. 7 is the cross-sectional view taken through the D-D line in FIG. 5;

FIG. 8 is the top perspective assembly view of the present invention.

FIG. 9 is the cross-sectional view taken through the E-E line in FIG. 8;

FIG. 10 is the schematic illustration of a positioning part according to the second embodiment of the present invention;

FIG. 11 is the schematic illustration of a positioning part according to the third embodiment of the present invention;

FIG. 12 is the schematic illustration of a pivoting axle according to the second embodiment of the present invention; and

FIG. 13 is the schematic illustration of a pivoting axle according to the third embodiment of the present invention.

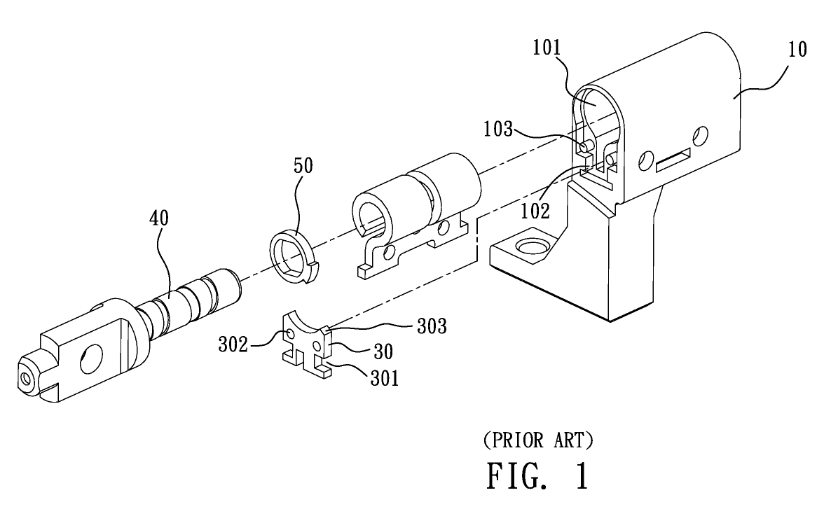

### DETAILED DESCRIPTION OF THE INVENTION

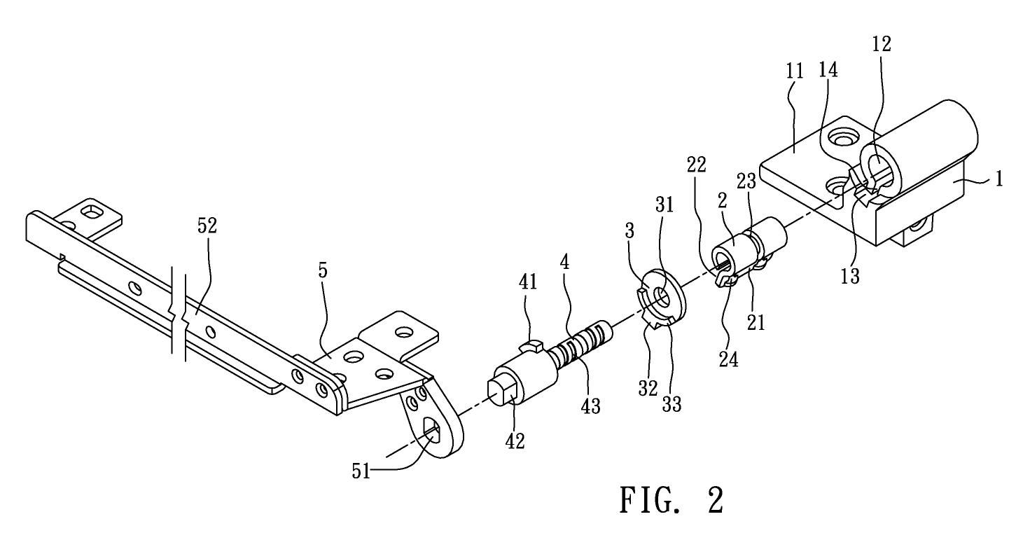

With reference to FIGS. 2 to 4, a pivotal device according to the present invention comprises a fixing part 1, a wrapping part 2, a positioning part 3, and a pivoting axle 4, wherein the pivoting axle 4 may be further connected with a supporting frame 5.

The fixing part 1 is a base body made of soft metal, die-cast zinc alloy for example. The fixing part 1 comprises a connection portion 11 to connect with an object, the main body of a notebook computer for example. The fixing part 1 is axially formed to have an axle hole 12 which is adjacent with an appropriate position of the positioning part 3, a notch 13 at the lower arc surface for example, to connect with the positioning part 3.

The axle hole 12 may be fittingly connected therein with a harder material, a wrapping part 2 made of stainless steel for example. To position the wrapping part 2, the axle hole 12 is radially communicating with an embedding slot 14 which extends laterally to communicatingly form an engagement slot 15 (as shown in FIG. 7).

The wrapping part 2 is a hollow, elastic tube socketingly connected into the axle hole 12. To enable the wrapping part 2 securingly fixed onto the axle hole 12 therein, the wrapping part 2 extends radially from one side to form a protruded plate 21 and on the other end forms a gap 22 with the protruded plate 21 so as to provide the wrapping part 2 with an elastic extension function. When the wrapping part 2 is to be connected with the fixing part 1, the wrapping part 2 and the protruded plate 21 are inserted aiming at the axle hole 12 and the embedding slot 14.

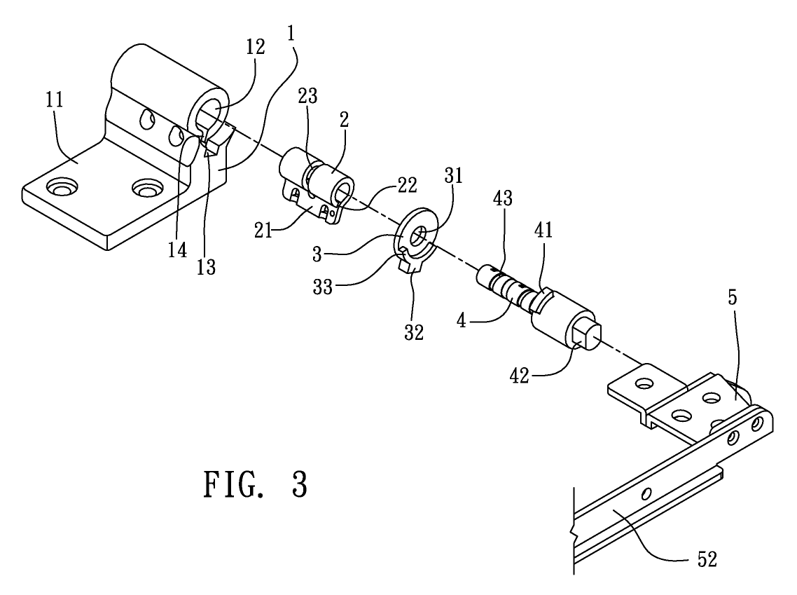

With reference to FIGS. 2 and 3, the wrapping part 2 is preferably divided with a cut groove 23 to provide a variety of torsional force. The gaps 22 of the least two tubes can be arranged in the same or reverse direction. Further, the protruded plate 21 corresponding to the engagement slot 15 is disposed with a protruded rib 24 so as to be embeddingly inserted into the engagement slot 15, prevent the wrapping part 2 from wobbling due to the rotation of the pivoting axle 4.

The positioning part 3 is a plate made of hard material, stainless steel for example, or other steel heat treated to be harder and stronger than the fixing part 1. The positioning part 3 is formed to have a through hole 31 for the insertion of the pivoting axle 4 which is then pivoted on the wrapping part 2 inside the fixing part 1. The positioning part 3 corresponding to the notch 13 of the fixing part 1 is protruded to form a protrusion 32, so that after the notch 13 and the protrusion 32 are engaged together, the positioning part 3 is securingly fixed on one side of the axle hole 12.

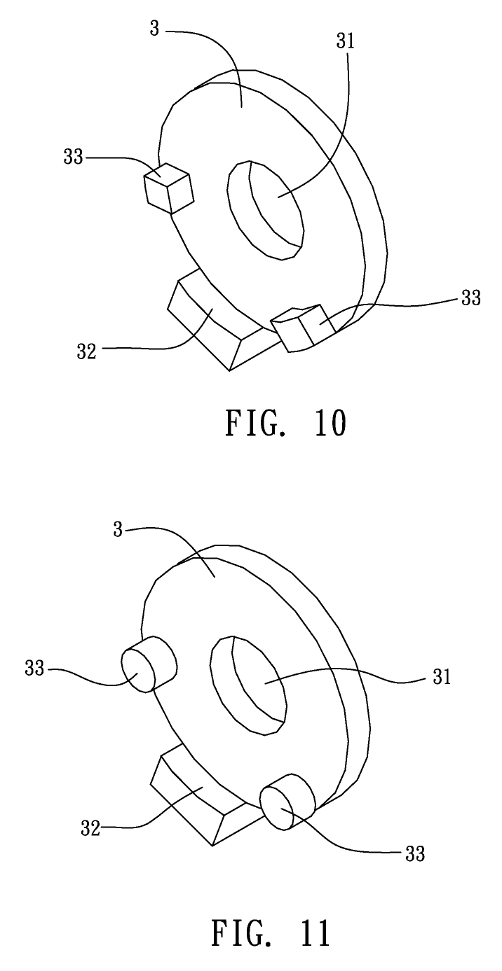

Further, the positioning part 3 adjacent with the positioning portion 41 of the pivoting axle 4 is disposed with a stop portion 33 which provides stopping and positioning functions when the pivoting axle 4 is rotating. With reference to FIGS. 2 and 3, the stop portion 33 is, for example but not limited to, a protruded arc rib. When the stop portion 33 is implemented, it may be embodied as the two positioning protrusions shown in FIG. 10 or the two positioning rods shown in FIG. 11, so as to limit the rotation angle of the pivoting axle 4.

The pivoting axle 4 is a rod which is inserted through the through hole 31 of the positioning part 3 and then pivoted on the wrapping part 2 inside the axle hole 12 of the fixing part 1, such that the pivoting axle 4 is rotatable with respect to the fixing part 1 and the expected frictional torsion can be generated therebetween. The generation of frictional torsion in this way is a conventional art and will not be discussed hereafter. The pivoting axle 4 on its one side is disposed with a positioning portion 41 which can be moved together with the pivoting axle 4. Consequently, when the pivoting axle 4 is rotating, the positioning portion 41 is rotating jointly and the two ends of the stop portion 33 are used to limit the rotation angle. The pivoting axle 4 may be disposed with a linkage portion 42, a pin for example, to connect with an object, the cover body of a notebook computer for example, by inserting the linkage portion 42 into a corresponding fixing hole 51 disposed on the supporting frame 5, such that the pivoting axle 4 rotates jointly with the movement of the supporting frame 5. Also, the surface of the pivoting axle 4 is cut to form oil groove 43 to lubricate the contact surfaces of the pivoting axle 4 and the wrapping part 2.

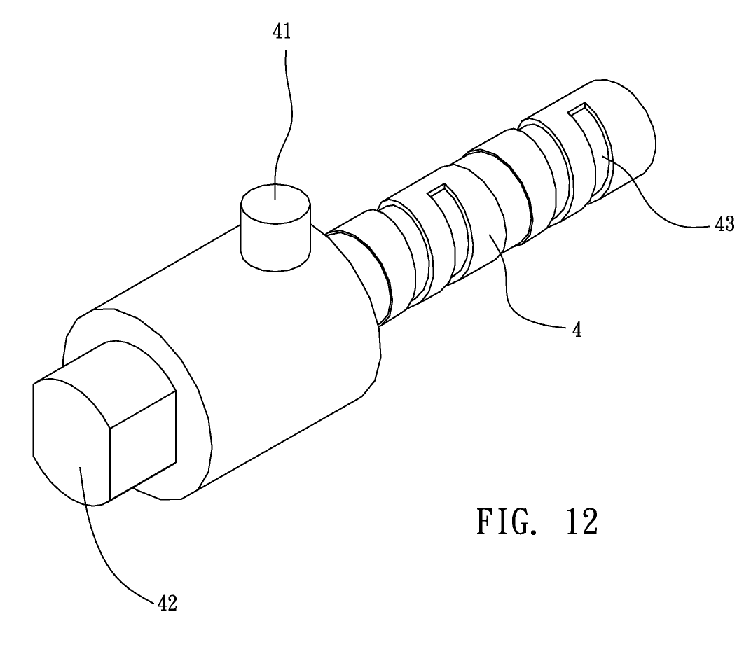

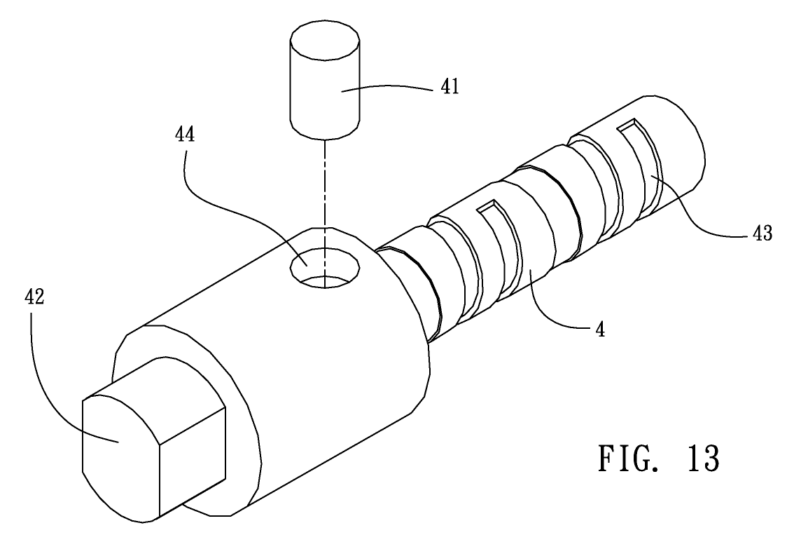

With reference to FIGS. 2 and 3, the positioning portion 41 of the pivoting axle 4 is, for example but not limited to, a protruded, fan-shaped positioning block integratedly formed. When the positioning portion 41 is implemented, it can also be made as a protruded positioning pin integratedly formed as shown in FIG. 12, or a pin hole 44 inserted with a positioning pin as shown in FIG. 13, such that the positioning portion 41 abuts against the two ends of the stop portion 33 of the positioning part 3 as a way to limit the rotation angle of the pivoting axle 4.

Moreover, the present invention further comprises a supporting frame 5 which at its lower end is disposed with a fixing hole 51 so as to be socketingly connected with the linkage portion 42, a pin for example, of the pivoting axle 4. The supporting frame 5 at its one side is disposed with a support arm 52 to be connected with the LCD (liquid crystal display) panel inside the cover body.

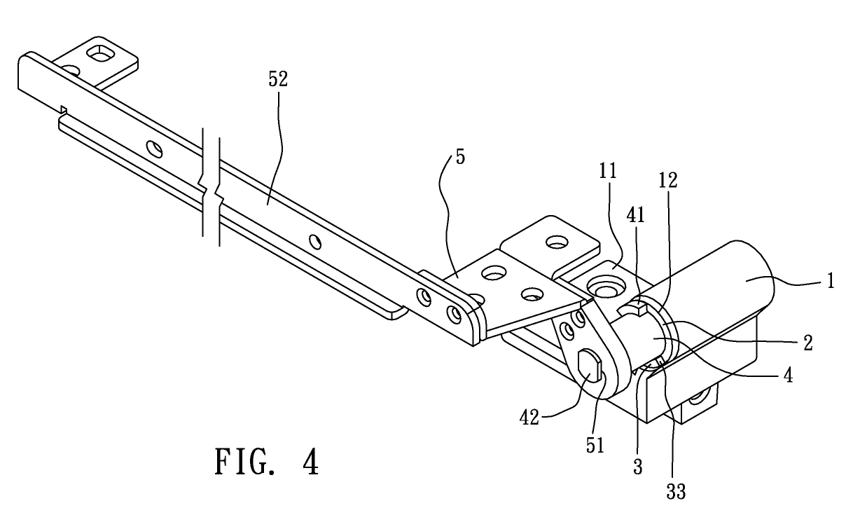

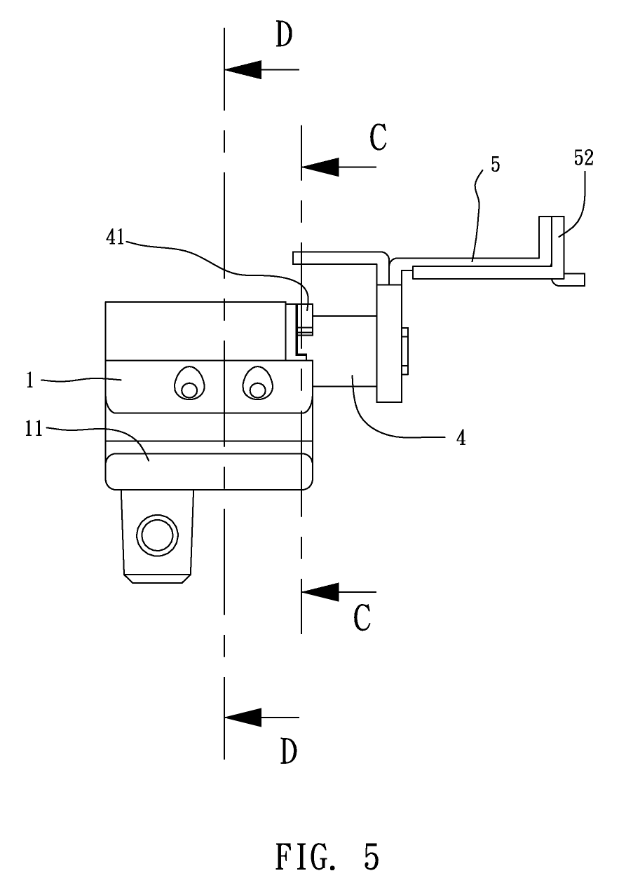

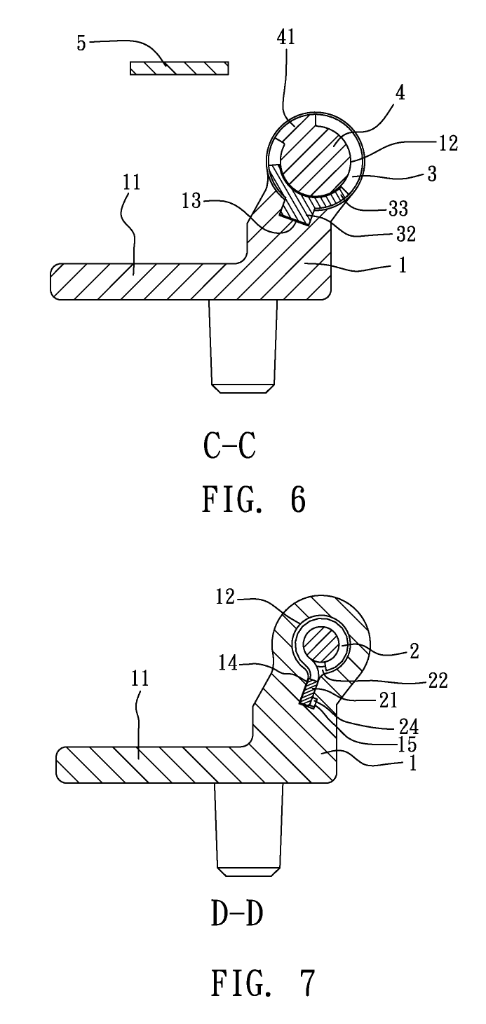

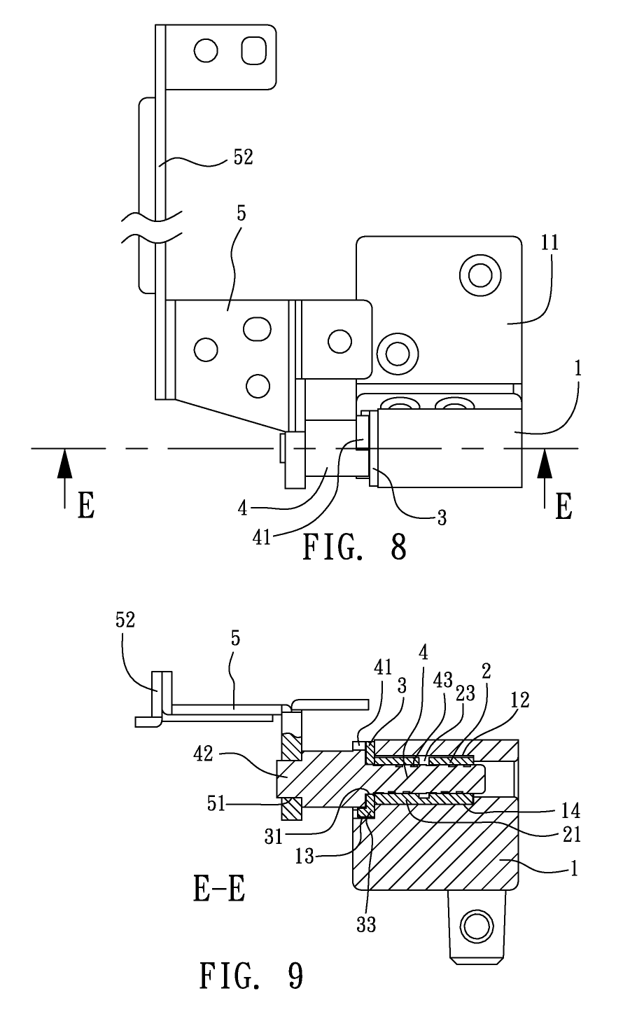

With the aforementioned descriptions of various parts and their assembly according to the present invention, the perspective assembly view of the present invention is shown in FIG. 4. FIG. 5, the rear perspective assembly view of the present invention, further explains the positioning part 3 and the wrapping part 2 are securingly fixed onto the notch 13 and the axle hole 12, respectively, of the fixing part 1. The cross-sectional views taken through the C-C and D-D lines in FIG. 5 are shown in FIGS. 6 and 7, respectively. From FIG. 6, it can be clearly observed that the protrusion 32 of the positioning part 3 is connected onto the notch 1 3 of the fixing part 1; also, FIG. 7 clearly shows that the wrapping part 2 is socketingly connected onto the axle hole 12 of the fixing part 1 and the radially-extended protruded plate 21 is embeddedly inserted within the embedding slot 14, which is communicatingly linked with the axle hole 12, and the protruded rib 24 projected laterally from the protruded plate 21 is accommodated within the engagement slot 15 so as to securingly fix the wrapping part 2 within the fixing part 1. Also reference to FIG. 8, the top perspective assembly view of the present invention, it further clarifies the assembly relationship of the pivoting axle 4 and the wrapping part 2 being securingly fixed the axle hole 12 of the fixing part 1. The cross-sectional view taken through the E-E line in FIG. 8 is shown in FIG. 9, in which the pivoting axle 4 rotates within the wrapping part 2 to generate frictional torsion therebetween and thus achieve a pivotal device.

With the implementation of the present invention, the drawback for a conventional pivoting axle to be socketingly connected with an additional limiting plate can be avoided so as to reduce the number of parts employed. The approach adopt here can achieve a simplified structure and assembly process, providing an enhanced service life as well as improved stopping and positioning precision for pivotal device. The present invention can thus overcome the drawbacks of conventional art and is indeed a breakthrough of its kind.

While the invention has been described with reference to the a preferred embodiment thereof, it is to be understood that modifications or variations may be easily made without departing from the spirit of this invention, which is defined by the appended claims.

What is claimed is:

1. A stopping and positioning mechanism for pivotal device, comprising
a fixing part having a notch;
a positioning part having a through hole and a protrusion; and
a pivoting axle having a positioning portion; wherein the fixing part is disposed with a wrapping part therein, the protrusion of the positioning part is securingly fixed onto the notch of the fixing part, and the pivoting axle is passing through the through hole of the positioning part and pivoted within the wrapping part; when the pivoting axle is rotating, the positioning portion of the pivoting axle is abutted against the stop portion of the positioning part, thereby limiting the rotation angle of the pivoting axle.

2. The stopping and positioning mechanism for pivotal device as defined in claim 1, wherein the positioning portion of the pivoting axle is an integratedly formed positioning block.

3. The stopping and positioning mechanism for pivotal device as defined in claim 1, wherein the positioning portion of the pivoting axle comprises a pin hole inserted with a positioning pin.

4. The stopping and positioning mechanism for pivotal device as defined in claim 1, wherein the stop portion of the positioning part is a protruded arc rib and when the pivoting axle is rotating, the positioning portion of the pivoting axle is abutted against both ends of the protruded arc rib, thereby limiting the rotation angle of the pivoting axle.

5. The stopping and positioning mechanism for pivotal device as defined in claim 1, wherein the stop portion of the positioning part comprises two positioning protrusions or two positioning rods and when the pivoting axle is rotating, the positioning portion of the pivoting axle is abutted against the two positioning protrusions or two positioning rods, thereby limiting the rotation angle of the pivoting axle.

6. The stopping and positioning mechanism for pivotal device as defined in claim 1, wherein the surface of the pivoting axle is cut to form oil groove.

7. The stopping and positioning mechanism for pivotal device as defined in claim 1, wherein the pivoting axle further comprises a pin for inserting and securing the fixing hole of a supporting frame.

8. A stopping and positioning mechanism for pivotal device, comprising a fixing part having a wrapping part therein;
a positioning part having a through hole and a stop portion; and
a pivoting axle having a positioning portion; wherein the positioning part is embeddedly positioned onto the fixing part, and the pivoting axle is inserted into the through hole and pivoted within the wrapping part; when the pivoting axle is rotating, the positioning portion of the pivoting axle is abutted against the stop portion of the positioning part, thereby limiting the rotation angle of the pivoting axle.

9. The stopping and positioning mechanism for pivotal device as defined in claim 8, wherein the pivoting axle may be further securingly connected with a supporting frame.
